(19) United States
(12) Patent Application Publication
(10) Pub. No.: US 2004/0056767 A1
(43) Pub. Date: Mar. 25, 2004

(54) Container security system

(76) Inventor: Dave Porter, Greer, SC (US)

Correspondence Address: Henry S. Jaudon, McNair Law Firm, P.A., P.O. Box 10827, Greenville, SC, 29603, US

(21) Appl. No.: 10/634,110

(22) Filed: Aug. 4, 2003

Related U.S. Application Data
(60) Provisional application No. 60/401,702, filed on Aug. 7, 2002.

(51) Int. Cl. G08B 13/00

(52) U.S. Cl. 340/541; 340/545.6; 340/825.49; 340/571

(57) ABSTRACT

A sensor device for monitoring conditions within an interior of an enclosed container which is operative to detect changes in conditions within the container caused by tampering or unauthorized access to the container. The sensor device includes a sensor dome, having a sensor, positioned within the container. An external status indicator is positioned on an exterior of the container and in communication with the sensor. The status indicator signals the current security status within the container based the signal output of the sensor. The indicator has a first condition signaling a secured status and a second condition signaling a breached status. The signals include a visual signal for an inspector on the exterior of the container indicating an unbreached or a breached container.

### FIELD OF THE INVENTION

The present invention relates to security devices for storage containers, and more particularly, to a sensor device for indicating the status of a storage container between secured state and a breached state by monitoring environmental conditions within the storage container for changes.

### BACKGROUND OF THE INVENTION

Storage containers of the type used in the trucking and shipping industries have had serious problems with unauthorized access, to which significant attention has recently been paid. Much of this attention, however, has focused on preventing access to the storage containers by providing better and stronger locking means. Given the extensive amount of time that the storage containers may be in transit on ships, trucks and sitting in customs areas, the majority of these locks simply provide a false sense of security as they can be easily defeated given the extended time an individual would have in order to overcome the lock.

Additionally, oftentimes the breach to the storage container may go unnoticed and there is no way to determine that the breach occurred without inspecting the inside of the container. Furthermore, with the increase in terrorist and criminal activity, it is necessary to be able to detect certain types of radiological weapons that may attempt to be transported illegally through storage containers.

Thus, there is a need for a device which can monitor the environment inside, and immediately surrounding the storage container to determine that a breach has occurred, the type and date of breach, notify authorities that a breach has occurred. Also there is a need to determine if potentially dangerous or hazardous cargo is being transported.

Accordingly, it is therefore an object of the present invention to provide a sensor device capable of sensing a breach of a storage container and recording information as to the type of breach, the time and date when the breach occurred and transmitting the breach data to authorities.

It is another object of the present invention to provide a sensor device capable of sensing environmental changes within a storage container, such as changes in light, heat, motion, pressure, and radiation to determine a potential unauthorized access of the storage container.

It is another object of the present invention to provide a sensor device capable of transmitting information about a specific storage container to a global positioning system to notify authorities of a possible breach of the storage container.

It is another object of the present invention to provide a sensor deice incorporating visual indicators carried on the exterior of the storage container for displaying the current security status, breached or secure, of the storage container.

Finally, it is an object of the current invention to provide a sensor device capable of receiving and transmitting data as to the contents, origin and destination of a storage container.

### SUMMARY OF THE INVENTION

The above objectives are accomplished according to the present invention by providing a sensor device capable of detecting a breach of the storage container and recording information as to the type, time and date of breach. The sensor device includes various sensors capable of detecting environmental changes in light, heat, motion, temperature, pressure, and radiation. Preferably, the sensor device is capable of transmitting information to a global positioning system to notify authorities of a breach. In order to indicate a breach of the container to an inspector, the sensor device incorporates visual indicators displaying the current status of the storage container. In a further advantageous embodiment, the sensor device is capable of receiving and transmitting data as to the contents of the storage container, as well, as the type, time and date of a breach to the storage container.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a set of storage containers including a sensor device capable of sending and receiving information according to the invention;

FIG. 1a shows an exploded exterior view of the sensor according to the invention;

FIG. 2 is a side view of the sensor device according to the invention;

FIG. 3 is a front view of the sensor device according to the invention;

FIG. 4 is a rear view of the sensor device according to the invention;

FIG. 5 shows a schematic representation as to the interaction between the environment in the storage container, the detection of changing conditions by the sensor device, and the visual indicators of the sensor device representing the status of the container according to the invention;

FIG. 6 is a schematic of the sensor device according to the invention;

FIG. 7 is a flow chart depicting the various conditions that control the visual indicators of the sensor device according to the invention;

FIG. 8 is a flow chart showing the interaction between the sensor device and a wireless device for transmitting data according to the invention; and

FIG. 9 shows a flow chart of the software used by the wireless device to interact with the sensor device according to the invention.

### DESCRIPTION OF A PREFERRED EMBODIMENT

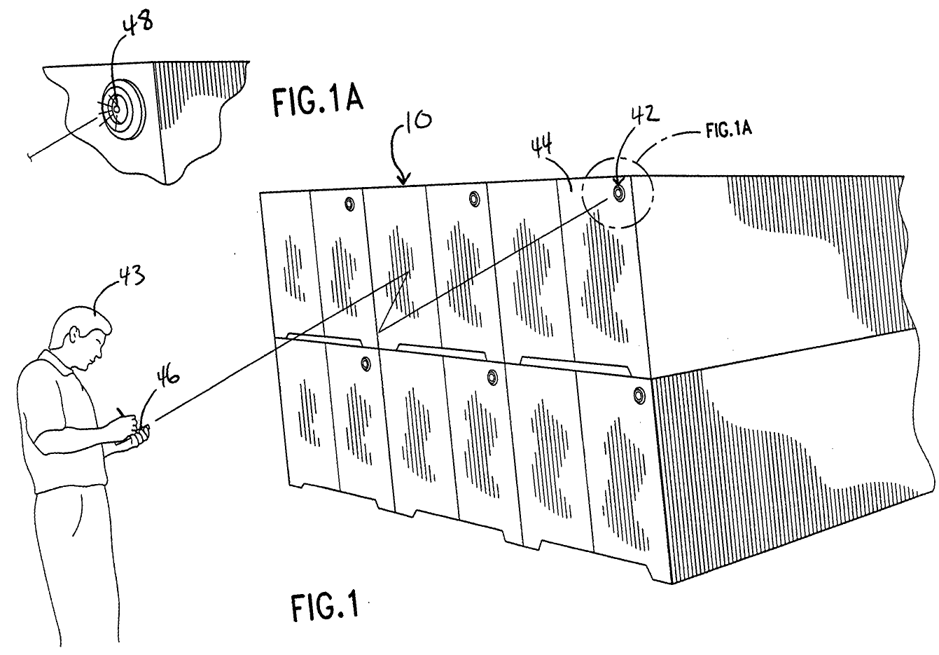

Referring now to the drawings, the invention will now be described in more detail. As is illustrated by FIG. 1, a plurality of storage containers 10 are shown in stacked alignment. Each of the storage containers includes a sensor device, designated generally as 42, for monitoring changes to the environment inside the storage container. The sensor device indicates the status of the storage container as being in a secured state or a breached state based on changes, or lack thereof, in the environmental conditions inside the storage container. When the storage container is closed and the sensor activated, it is presumably in a secured state with the environmental conditions remaining within a specific range accepted by the sensor device. When a change in the environmental conditions within the storage container occurs, any changes such as a change in light, heat, motion, pressure, or radiation, beyond the specified accepted range is registered by the sensor which then indicates a breached state, preferably using a visual indicator. As is discussed in further detail below, sensor 42 also includes the ability to store electronic information about the contents within the storage container and information as to a breach of the storage container.

In the shown arrangement, sensor 42 is mounted in the upper right hand corner of container door 44. In this location it is easily visible to an inspector 43 who can request status and manifest information through wireless device 46 from sensor 42. Preferably, as is depicted in FIG. 1a, sensor 42 includes a visual indicator 48 which immediately indicates to an inspector the current status (secured or breached) of the storage container. In this manner, inspector 43 may simply glance at a stack of storage containers and determine from the visual indictors of the sensor if there has been a breach to any one of the storage containers.

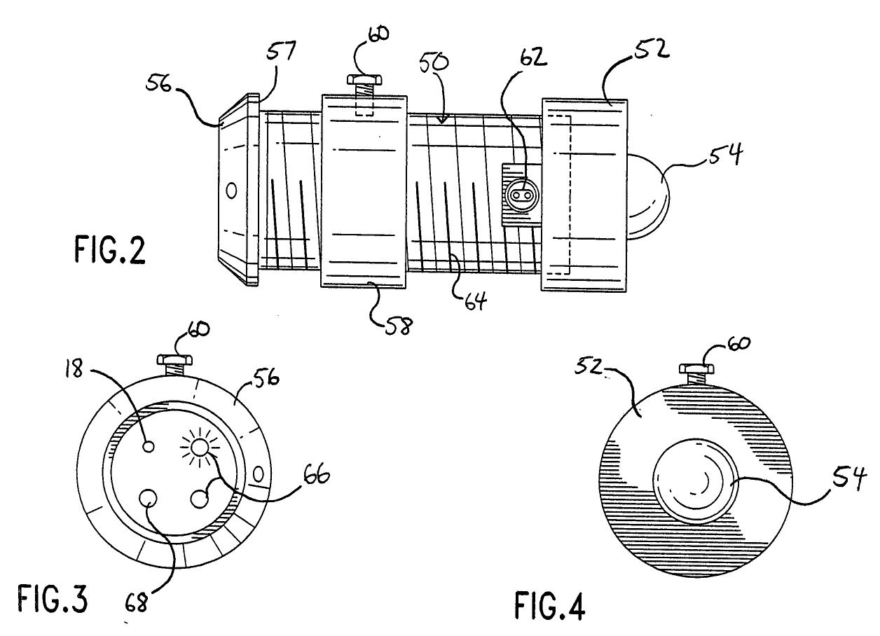

Referring to FIG. 2, the sensor includes a housing 50 which is mounted in container door 44 (FIG. 1). A first end of housing 50 forms an external indicator portion 56 which is carried on the exterior side of the storage container and includes the visual indicator 48. The exterior of housing 50 includes threads 64 which receive complementary threads from a locking collar 58. Collar 58 secures housing 50 to container door 44 by tightening collar 58 against the interior side of door 44 which pulls flange 57 of external indictor portion 56 tight against the exterior side of container door 44. Once the collar has been sufficiently tightened, set screw 60 is secured against housing 50 to prevent lock collar 58 from backing off in order to maintain the tight fit with container door 44. In this fashion, sensor 42 cannot be removed from the storage container without first gaining entry to the container itself and loosening collar 58. Housing 50 includes various computer hardware and software components, as well as a power supply for operating the sensor device, which are described in detail below.

Referring to FIGS. 2 and 4, sensor 42 includes a sensor cap 52 carried at a second end of housing 50 opposite external indicator portion 56, secured in place on the end of the housing by threads 64. Sensor cap 52 includes various sensors commonly known to a person skilled in the art for monitoring the environment inside an enclosed area, and in the case of a radiation sensor, even monitoring the area immediately surrounding the area for radiation. In the preferred embodiment, sensor cap 52 contains a sensor for detecting a change in any user defined variable or a change in conditions outside a specific predetermined range. For example a sensor for changes in light, heat, motion, radiation, pressure, or sound, where the change could be any deviation from a norm, or a change that falls outside a given range, such as a temperature range. The above examples are provided for illustrative purposes of the preferred embodiment and are not exclusive. Any sensor used to monitor a change in environmental conditions may be used and is considered within the spirit and scope of this invention.

As depicted in FIG. 2, sensor cap 52 includes a sensor dome 54 into which any of the aforementioned sensors extend and receive various environmental information from the storage container. The extended sensor dome 54 allows the sensor to receive the maximum sensory information from the container environment. Preferably, the sensor dome is made from a durable plastic material that allows the sensors to remain protected, while still allowing for limited interference in detecting environmental changes within the container.

Additionally, it is advantageous to provide the sensor with an external global positioning system (GPS) port 62 as shown in FIG. 2. This allows the sensor to monitor the current location of the storage container and transmit current status information, or in the event of a breach, to notify authorities of a breach. It is to be understood that the storage container must be equipped with the proper GPS transmitting equipment, well known in the art, to take advantage of the GPS port contained within the sensor device.

Referring to the external portion 56 of the sensor, as shown in FIG. 3, a plurality of visual indicators are provided. In the preferred embodiment a single green light 68 is provided which flashes to indicate a secured state. In the event of a breach detected by the sensor device, blue indicator light 66 will flash to notify the inspector that the container was breached or a condition otherwise occurred to cause the sensor to indicate a change in condition. Additionally, external portion 56 includes an infrared port 18 which transmits and receives information from a wireless device 46, as shown in FIG. 1 and as discussed below.

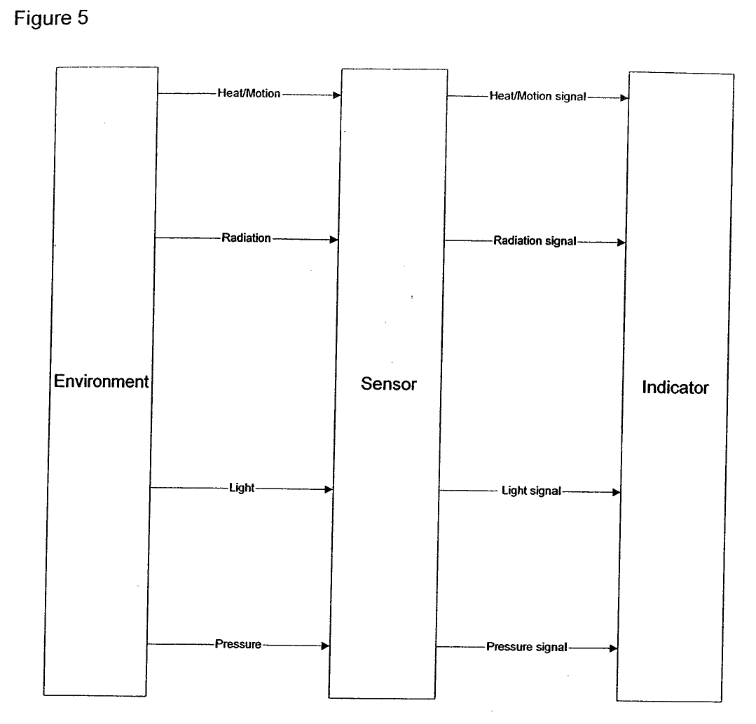

Referring to FIG. 5, once the storage container is loaded and the sensor activated, the environment, designated generally as 150, inside the container will be monitored for changes in heat, motion, radiation, light and pressure. If for example, the sensor were to detect a sudden change in light as a result of someone opening a door to the storage container or drilling a hole in the side of the container, the sensor would register that change and send a signal to the indicator light 66 which would begin to flash blue. The visual indicator would continue to flash blue until an inspector examined the container and determined that the sensor could be reset. The inspector transmits a security code verifying the authority to reset the sensor and activate green flashing light 68.

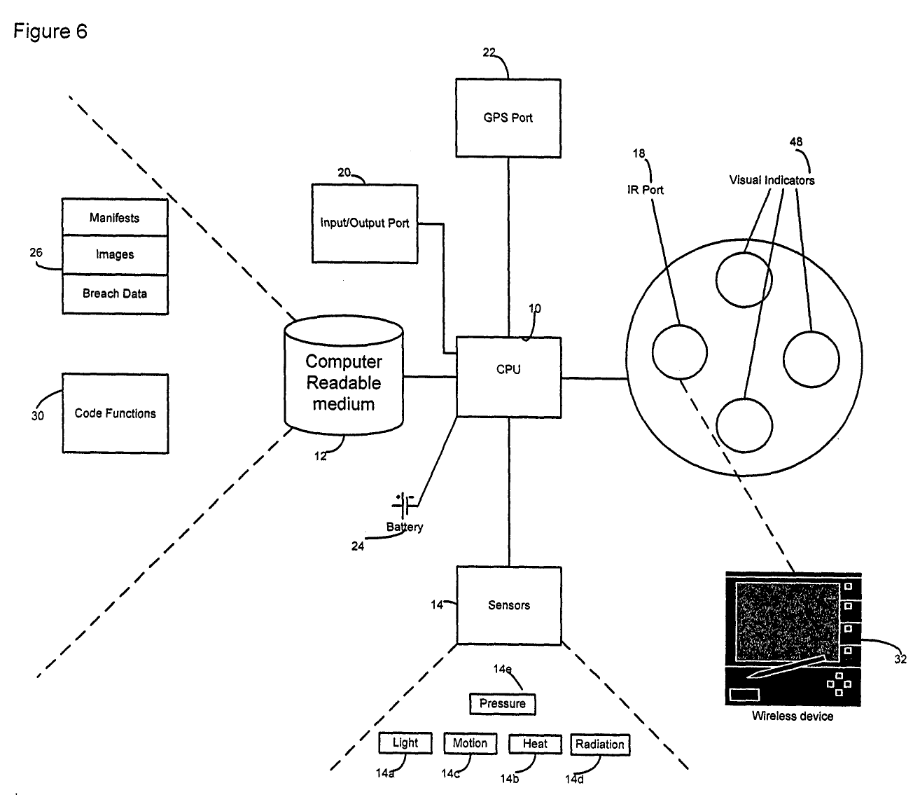

Referring now to FIG. 6, a schematic of the invention is shown. Central processing unit (CPU) 10 is in communication with a compute readable medium 12. A set of computer readable instructions is embodied within computer readable medium 12 which functions to provide a norm against which the sensed information is compared to and provides the functionality for this invention. Sensors 14 are in communication with said computer readable medium either directly or through processor 10. Preferably, sensors include light sensor 14a, heat sensor 14b, motion sensor 14c, radiation sensor 14d, and pressure sensor 14e in any combination thereof or individually carried by sensor cap 52, or within housing 50 of the sensor 42. These sensors are able to monitor the respective environment conditions within the container and indicate whether light, heat, motion, radiation, or pressure has changed since the sensor was activated.

These sensors supply a signal to CPU 10 that can be used to and communicated to the computer readable medium 12. Visual indicators 48 are in communication with either CPU 10, computer readable medium 12, or both and provide external indications when actuated. Preferably, the indicators are flashing lights, but may include sound and/or motion creating devices to indicate the current status of the storage container. For example, an indicator can show the color green for a normal condition with the color blue, red, or other color indicating a different condition than normal. In an example, when sensor 14e detects changes in radioactive radiation emissions, CPU 10, with the assistance of computer readable instructions 12, activates visual indicator 48 to provide for blue flashing light 66 indicating a change from the normal, in this case, the present of a certain radiation level.

Infrared port 18 is in communications with CPU 10 and computer readable medium 12 for transmitting and receiving information to and from the computer readable medium. Additionally, other input-output ports 20 can be in communication with CPU 10 and/or computer readable medium 12 such as RS232, serial parallel, radio, or other means of communicating electronic signals. In the preferred embodiment, a GPS system 22 can be in communications with CPU 10 and/or computer readable medium 12. Therefore, computer readable instructions embodied in the computer readable medium can receive a position signal from GPS 22 and store the location of the container at a particular interval. Power supply 24 can be in communication with CPU 10, computer readable medium 12, GS 22, port 20, IR port 18, indicator 48, and sensors 14 so as to supply them with power. Computer readable medium 12 can also contain manifest or bill of lading information 26 which can represent the contents of a container. Images 26 can also be included in computer readable medium 12 so as to store images of the contents of the container. Computer readable instructions 30 provide the functionality and embodiment in computer readable medium 12. Computer readable instructions 30 can record events detected by the sensor, such as the existence or changes in light, heat, motion, radiation or pressure and associate a date, time and location through GPS 22. The computer readable instructions can also record attributes of each sensor such as, for example, the strength, location, the time and date that radiation is detected.

Input device 32 can be in communication with CPU 10 and computer readable medium 12 for inputting and outputting information to and from the compute readable medium. Input device 32 can be a PDA such as a palm pilot, laptop or other device, as illustrated by wireless device 46 in FIG. 1, able to transmit signals to and from the CPU 10 and/or compute readable medium 12 through IR port 18 or other input/output port 20. Computer readable instructions embodied in the computer readable medium are able to detect a sensor signal from sensors 14 representing a change or presence of light, heat, motion, radiation or pressure. Upon the sensor detecting such a change, the sensors transmit the information to CPU 10, which in turn activates indicator 48 according to the sensor signal.

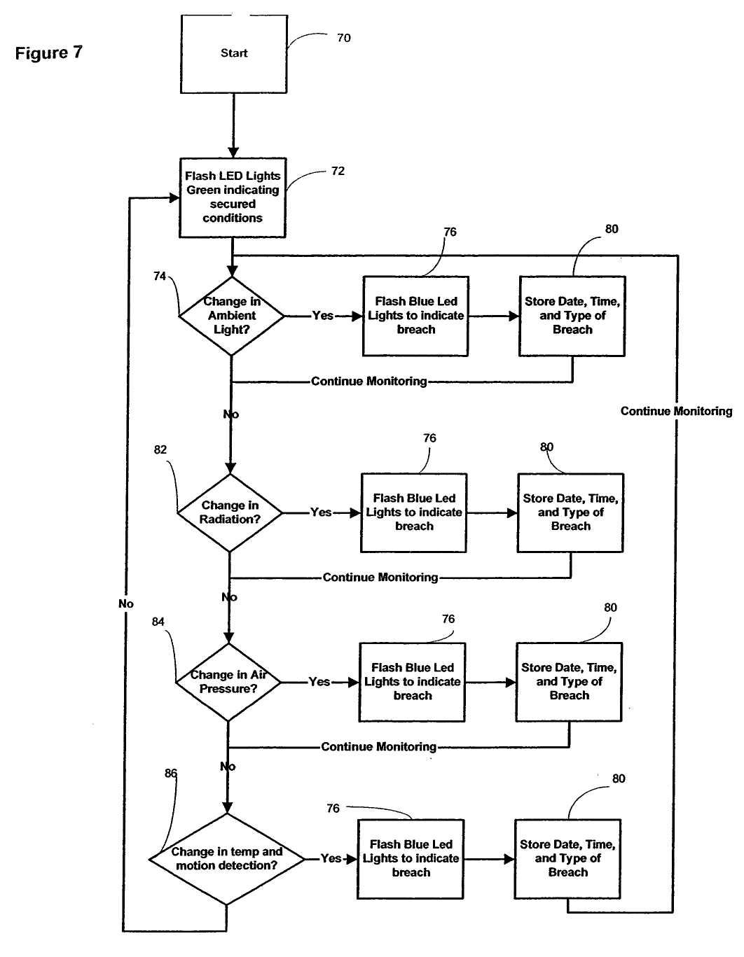

Referring now to FIG. 7, a flow chart is shown depicting the various changes in conditions that will switch visual indicator 48 from a green flashing light to a blue flashing light to signal a breach of the storage container. At position 70 the sensor device is activated and causes the green indicator light to flash indicating a secured condition, as depicted in step 72. The sensor device will continue to signal a green flashing indicator until a change in condition will switch the visual indicator to flashing blue lights. As depicted in step 74, a change in light would lead to flashing blue indicators representative of a breach of the storage container as depicted in step 76. Once a breach occurs, the date, time and type of breach is stored in the sensor device. Additionally, if the sensor device is connected to a GPS system, it would send a signal notifying authorities of the date, time and type of breach and location of the container. The sensor device will then continue to monitor for additional changes in condition, such as a change in radiation levels at step 82, a change in air pressure at step 84, or a change in temperature and motion at step 86. In each of steps 74, 82, 84 and 86 a change in condition will lead to a flashing blue visual indicator representative of a breached status for the storage container requiring the attention of an inspector or other authority personnel. As is clearly depicted by FIG. 7, if no breach occurs the indicator will continue to flash green.

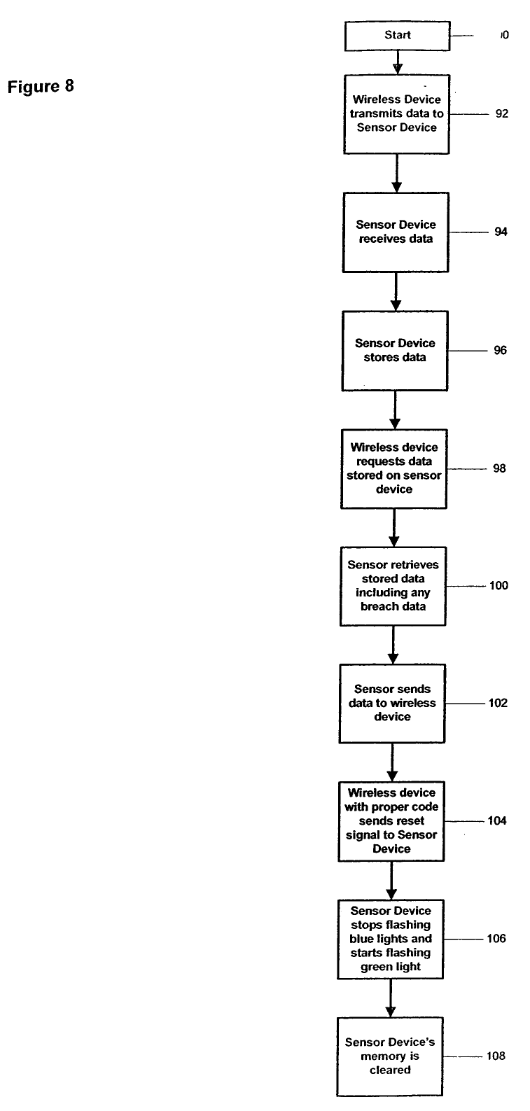

In the preferred embodiment, as shown in FIG. 1, inspector 43 uses an input device 32, such as wireless handheld device 46, to interact with sensor device 42. Referring to FIG. 8, a flow chart is illustrated showing the interaction between the wireless device 46 and sensor device 42. Once the sensor device is activated in step 90, the wireless device may transmit data to the sensor device in step 92. The sensor device will then receive that data as depicted by step 94 and store the data at step 96. As discussed above, this data may include the manifest or various other information about the container. Upon arrival of the storage container, inspector 43 may use wireless device 46 to request the data stored on the sensor device from its origination point, as depicted by step 98. The sensor device then retrieves the stored data including any information relating to a breach of the storage container, as depicted by step 100, and transmits the data to the wireless device through infrared or other wireless communication technology as depicted at step 102. Alternatively, the information can be transmitted through other input/output port 20. If the container was breached, the wireless device may then send a reset code to the sensor device, as depicted in step 104, which will reset the flashing blue indicator lights to the standard green light to indicate a secure condition as represented in step 106. Upon resetting the sensor device through steps 104 and 106, the sensor device's memory may at this point be cleared and ready to receive new or additional information, as represented by step 108.

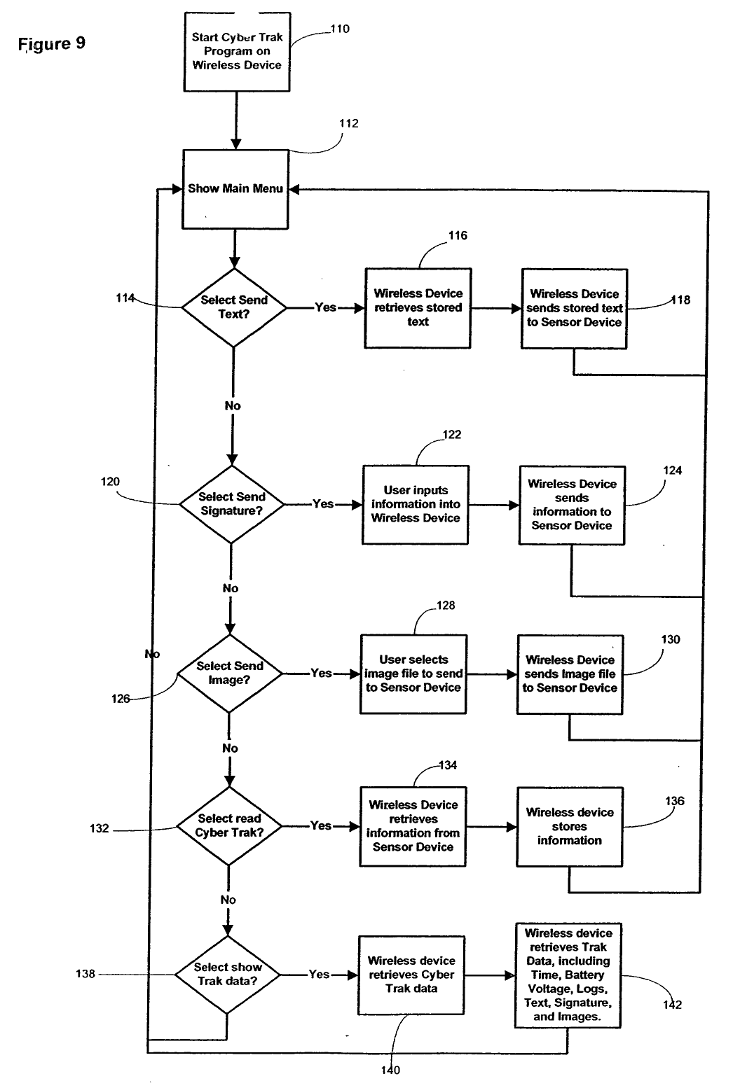

Referring to FIG. 9, in the preferred embodiment of the invention, the wireless handheld device 46 used by inspector 43 provides various options for sending and receiving information from sensor device 42. As depicted in step 110, the software for the wireless device is activated to interact with the sensor device. The software program includes a main menu 112 that allows the user to select from a variety of options. In the preferred embodiment, at step 114, the user may select to send text to the wireless device. In this instance, the wireless device will retrieve the stored text from memory at step 116 and transmit the stored text to the sensor device at step 118. At step 120 the user may select to send handwritten information designated by the term signature at step 120. In this case the user will input the information into the wireless device by either typing or writing through a user interface at step 122 and the software at step 124 will then transmit the information from the wireless device to the sensor device. Preferably, the user will have the ability to send image files depicting the contents of the storage container. Using this option, at step 128, the user will select an image file from information store don the wireless device at step 130. The user may also wish to retrieve information stored on the sensor device by selecting the option to read the sensor device at step 132. The wireless device will then transmit a signal to retrieve information stored on the sensor device at step 134 and store the information carried on the sensor device onto the wireless device at step 136. At step 138, the user may select to view the information on the wireless device which will retrieve the information stored on the device at step 140 and display information about the container, the battery voltage, time, logs, text, signature information, and image files, and any breach information, as depicted by step 142.

While a preferred embodiment of the invention has been described using specific terms, such description is for illustrative purposes only, and it is to be understood that changes and variations may be made without departing from the spirit or scope of the following claims.

What is claimed is:

1. A security system for monitoring the interior of an enclosed container said system comprising:
a sensing unit including a housing having first and second ends carried by said container, said first end being disposed within said container, and said second end being disposed outside said container;
a sensor carried in said first end for monitoring conditions within said container and signaling changes in said conditions;
a central processing unit in said housing in communication with said sensor said central processing unit receiving information monitored by said sensor; and comparing said information against a set of established parameters;
an external status indicator carried by second end of said housing for signaling current security status of the container as monitored by said sensor;
said indicator having a first condition signaling a secured status within said container and a second condition signaling a breach of said parameters has been detected by said sensor; and
a remote access device operatively associated with said sensor for deactivating and reactivating said sensor;
whereby said security system provides a signal on said exterior of the container whether the conditions within the container remain within said tolerances or have moved into a condition outside said tolerances indicating tampering or unauthorized access into said container.

2. The security system of claim 1 wherein said processing unit includes a computer readable medium for defining the type change within said container and the date and time of said change.

3. The security system of claim 2 wherein said change may constitute a change in light conditions, temperature, motion, sound, radiation and any combination thereof.

4. The security system of claim 1 wherein said remote access device is operative to receive, display and print condition information generated by said processing unit.

5. The security system of claim 1 wherein said remote accessing device includes a global positioning system, whereby said remote access device is operative to generate location at the time of breach.

6. The security system of claim 1 wherein said external status indicator includes indicator lights.

7. The security system of claim 1 wherein said housing includes a power source for operating said sensing unit.

8. The security system of claim 1 wherein said housing is removably mounted in an end wall or door of said container.

9. The security system of claim 1 wherein said container is portable by land and sea transport.

10. The security system of claim 1 wherein said second end includes an infrared port for receiving and transmitting information.

11. A sensor device for monitoring conditions within an interior of an enclosed container, said sensor device being operative to detect changes in conditions within said container caused by tampering or unauthorized access to the container, said sensor device comprising:
a sensor dome including a sensor positioned within said container for monitoring conditions within said container;
an external status indicator positioned on an exterior of said container in communication with said sensor, said status indictor signaling a current security status within said container based on signal output of said sensor;
said indicator having a first condition signaling a secured status and a second condition signaling a breached status;
whereby said external status indicator provides a visual signal to an inspector on the exterior of the container indicating an unbreached and a breached container.

12. The sensor device of claim 11 including a central processing unit associated with said sensor and status indicator, said processing unit being operative to monitor signals sent by said sensor, comparing said signals against a norm and sending signals to said status indicator indicating breach and no breach of said container interior.

13. The sensor device of claim 12 wherein said status indicator includes a port communicating with a wireless device, said port sending said breach and no breach signals to said wireless device.

14. The sensor device of claim 12 wherein said breach signal includes data indicating type of breach and time of breach.

15. The sensor device of claim 12 wherein said breach signal includes data indicating location of said container at the time of said breach.

16. The sensor device of claim 13 wherein said wireless device comprises one of a palm pilot, a laptop and a desk top.

17. A method of monitoring a shipping container comprising:
providing an exterior monitor and securing said exterior monitor with an outside surface of said container;
providing an interior monitor and positioning said interior monitor within said container;
causing said interior monitor to sense conditions within said container and to send signals in response to said conditions between secure condition and breached condition;
providing a central processing unit in communication with said interior and exterior monitors which receives secured condition and breached condition signals from said interior monitor indicating conditions within said container;
providing said exterior monitor with a plurality of signaling elements and activating selected of said elements in response to signals from said central processing unit; wherein,
when said container is in a secured condition a first signal is continuously provided indicating said container is in said secured condition and when said container is in a breached condition a second signal is continuously sent indicating said container is in said breached condition.

18. The method of claim 17 including providing that said interior monitor sense changes at least one of light conditions, temperature, sound and radiation.

19. The method of claim 17 including providing independent visual indicators for said exterior monitor.

20. The method of claim 17 including providing satellite communication and monitoring the location of said container.

21. The method of claim 17 including providing a remote access device in communication with said exterior monitor which functions to record at least one of date, time and location of a breach of said container.

22. The method of claim 17 including providing a remote access device in communication with said exterior monitor and said central processing unit which functions to activate, deactivate and re-set said central processing unit.
